(19) United States
(12) Patent Application Publication
(10) Pub. No.: US 2014/0350978 A1
(43) Pub. Date: Nov. 27, 2014

(54) METHOD, DEVICE AND STORAGE MEDIUM FOR RESERVATION BASED ON PANORAMIC MAP

(71) Applicant: TENCENT TECHNOLOGY (SHENZHEN) COMPANY LIMITED, Shenzhen City (CN)

(72) Inventor: HUA-FENG LI, Shenzhen City (CN)

(21) Appl. No.: 14/455,895

(22) Filed: Aug. 9, 2014

Related U.S. Application Data
(63) Continuation of application No. PCT/CN2014/071173, filed on Jan. 23, 2014.

(30) Foreign Application Priority Data
Feb. 6, 2013 (CN) 201310047538.3

(51) Int. Cl. G06Q 10/02; H04L 29/08; G06F 3/0484

(52) U.S. Cl. CPC G06Q 10/02; G06F 3/04842; H04L 67/32
USPC 705/5

(57) ABSTRACT

This document publishes a method, a device and a storage medium for reservation based on panoramic map. In one embodiment, the method includes the following steps: obtaining and displaying a panoramic map corresponding to a destination, the panoramic map having a plurality of reservations displayed thereon; detecting a navigation operation on the panoramic map by a user; in response to the navigation operation, displaying a part of the panoramic map corresponding to the navigation operation; receiving a selection request for selecting a reservation from the plurality of reservations on the part of the panoramic map; and sending the selection request to a server. According to the method, the device and the storage medium, it is possible to know the actual location and surroundings of various tables in the real world when the user makes reservation, so the intuition and accuracy of reservation is significantly improved.

### CROSS-REFERENCE

This application is a U.S. continuation application under 35 U.S.C. §111(a) claiming priority under 35 U.S.C. §§120 and 365(c) to International Application No. PCT/CN2014/071173 filed Jan. 23, 2014, which claims the priority benefit of Chinese Patent Application No. 201310047538.3, filed on Feb. 6, 2013, the contents of which are incorporated by reference herein in their entirety for all intended purposes.

### FIELD OF THE INVENTION

The present disclosure relates to map technique, and more particularly to a method, a device and a storage medium for reservation based on panoramic map.

### BACKGROUND OF THE INVENTION

The conventional reservation service usually includes manual service model and web service model.

In the manual service model, users may make a reservation by making a call to the service counter of the restaurant. However, the users cannot observe the position of various tables in the restaurant while the users selecting the one of the various tables. Therefore, the manual service is less intuitive for users.

The web service model provides an interface for the users to operate as shown in FIG. 1. The users may perform reservation operations in the interface. For example, the users may book tickets for concerts or movies in the interface. More specifically, when the users click on the interface to select their favorite location area, the interface shown in FIG. 1 will switch to a position select interface shown in FIG. 2. When the users select a specific location in the interface in FIG. 2, the interface will display the specific location of the seat, floor, bleaches, class fares, status and other information. However, since the interfaces in the web service are some virtually plans, not real scenarios, information obtained therefrom are relatively monotonous and have some differences with the actual environmental. After make a selection, users often find that their choice is not what they want. In other words, the conventional web service is not accurate enough.

### SUMMARY OF THE INVENTION

This disclosure provides a method, a device and a storage medium for reservation based on a panoramic map. The method, the device and the storage medium can improve intuition and accuracy of reservation.

In one embodiment, method for reservation based on a panoramic map on an electronic terminal, at the electronic terminal, the method includes the following steps: obtaining and displaying a panoramic map corresponding to a destination, the panoramic map having a plurality of reservations displayed thereon; detecting a navigation operation on the panoramic map by a user; in response to the navigation operation, displaying a part of the panoramic map corresponding to the navigation operation, to make the user select a reservation on the part of the panoramic map; receiving a selection request for selecting a reservation from the plurality of reservations on the part of the panoramic map; and sending the selection request to a server, to make reservation.

In another embodiment, a device for reservation based on a panoramic map on an electronic terminal, the device at the electronic terminal includes at least a processor operating in conjunction with a memory and a plurality of modules. The plurality of modules includes a first displaying module, a first detecting module, a second displaying module, a first receiving module, and a sending module. The first displaying module, configured to get and display a panoramic map corresponding to a destination, the panoramic map having a plurality of reservations displayed thereon. The first detecting module, configured to detect a navigation operation on the panoramic map by a user. The second displaying module, configured to display a part of the panoramic map corresponding to the navigation operation in response to the navigation operation, to make the user select a reservation on the part of the panoramic map. The first receiving module, configured to receive a selection request of the user for select a reservation from the plurality of reservations on the part of the panoramic map. The sending module, configured to send the selection request to a server, to make reservation.

In a yet another embodiment, a non-transitory computer-readable storage medium storing instructions for starting an application in an electronic terminal, the instructions includes: obtaining and displaying a panoramic map corresponding to a destination, the panoramic map having a plurality of reservations displayed thereon; detecting a navigation operation on the panoramic map by a user; in response to the navigation operation, displaying a part of the panoramic map corresponding to the navigation operation, to make the user select a reservation on the part of the panoramic map; receiving a selection request for selecting a reservation from the plurality of reservations on the part of the panoramic map; and sending the selection request to a server, to make reservation.

### BRIEF DESCRIPTION OF THE DRAWINGS

To illustrate the technical solution according to embodiments of the present disclosure more clearly, drawings to be used in the description of the embodiments are described in brief as follows. However, the drawings described herein are for illustrative purposes only of selected embodiments and not all possible implementations, and are not intended to limit the scope of the present disclosure. Corresponding reference numerals indicate corresponding parts throughout the several views of the drawings.

FIG. 1 illustrates one interface for the users to operate in the conventional web service.

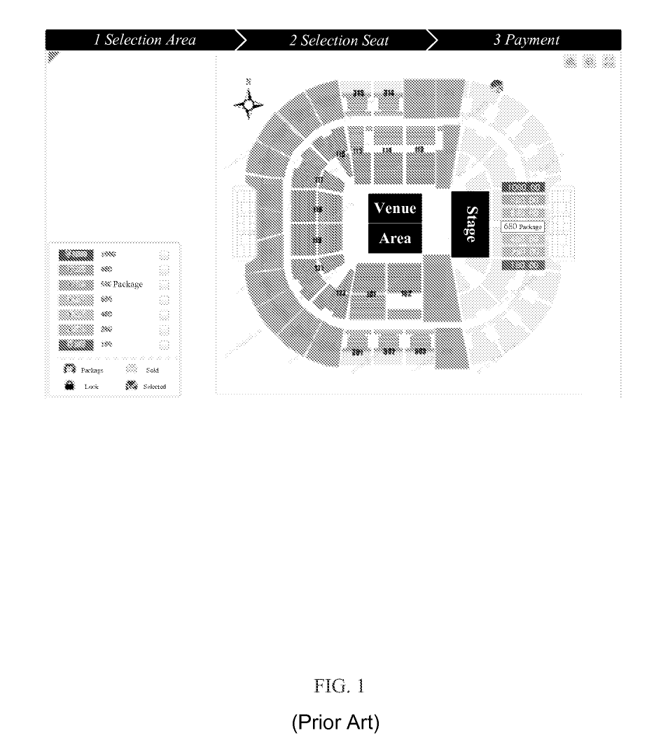

FIG. 2 illustrates another interface for the users to operate in the conventional web service.

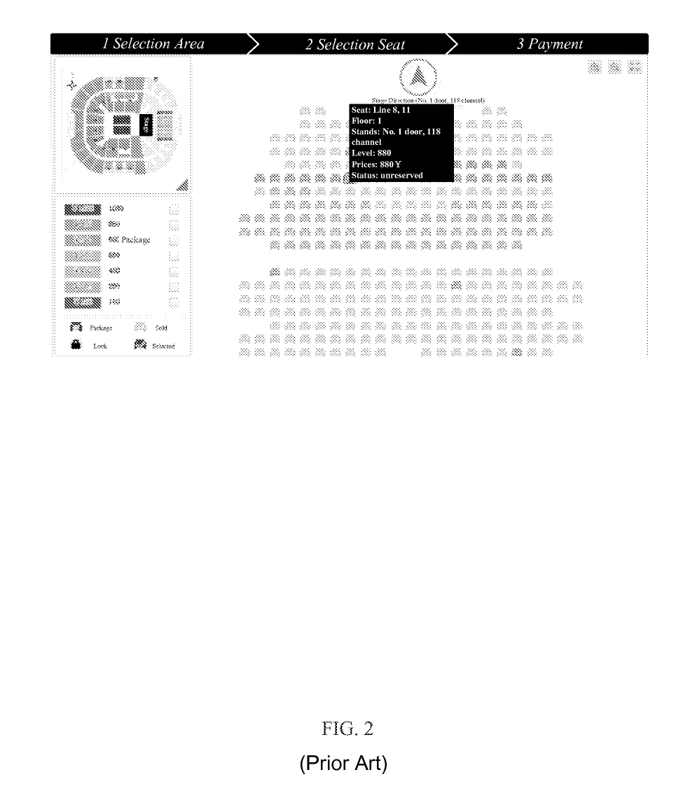

FIG. 3 illustrates a runtime environment according to various embodiments.

FIG. 4 is a block diagram illustrating an example of an electronic terminal.

FIG. 5 is a flowchart of one embodiment of a method for reservation based on a panoramic map on an electronic terminal in accordance with the present disclosure.

FIG. 6 is a flowchart of another embodiment of a method for reservation based on a panoramic map on an electronic terminal in accordance with the present disclosure.

FIG. 7 is a working sketch of another embodiment of a method for reservation based on a panoramic map on an electronic terminal in accordance with the present disclosure.

FIG. 8 is a schematic diagram of functional modules of one embodiment of a device for reservation based on a panoramic map on an electronic terminal in accordance with the present disclosure.

FIG. 9 is a schematic diagram of functional modules of another embodiment of a device for reservation based on a panoramic map on an electronic terminal in accordance with the present disclosure.

### DETAILED DESCRIPTION OF PREFERRED EMBODIMENTS

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments.

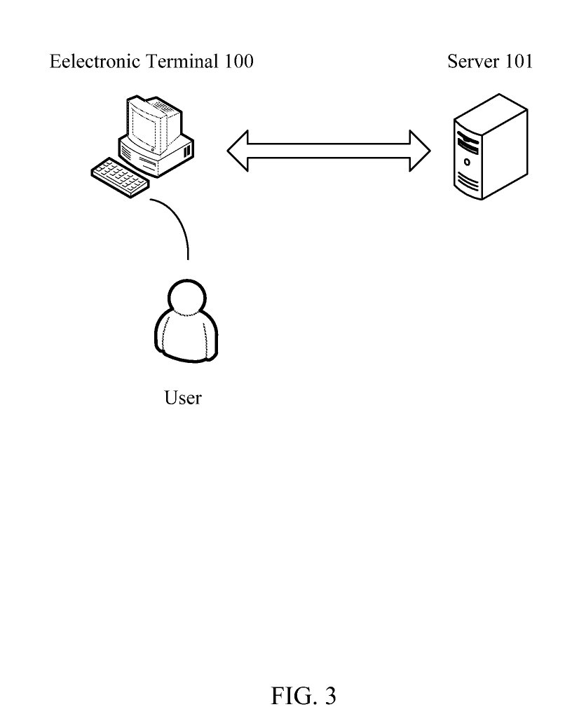

FIG. 3 illustrates a runtime environment according to some embodiments. The method for reservation based on a panoramic map can be applied to an electronic terminal. The electronic terminal 100 may be connected to a server 101 via a network such as internet or mobile communication network. Examples of the electronic terminals 100 includes, but are not limited to, a tablet PC (including, but not limited to, Apple iPad and other touch-screen devices running Apple iOS, Microsoft Surface and other touch-screen devices running the Windows operating system, and tablet devices running the Android operating system), a mobile phone, a smart phone (including, but not limited to, an Apple iPhone, a Windows Phone and other smart phones running Windows Mobile or Pocket PC operating systems, and smart phones running the Android operating system, the Blackberry operating system, or the Symbian operating system), an e-reader (including, but not limited to, Amazon Kindle and Barnes & Noble Nook), a laptop computer (including, but not limited to, computers running Apple Mac operating system, Windows operating system, Android operating system and/or Google Chrome operating system), or an on-vehicle device running any of the above-mentioned operating systems or any other operating systems, all of which are well known to those skilled in the art.

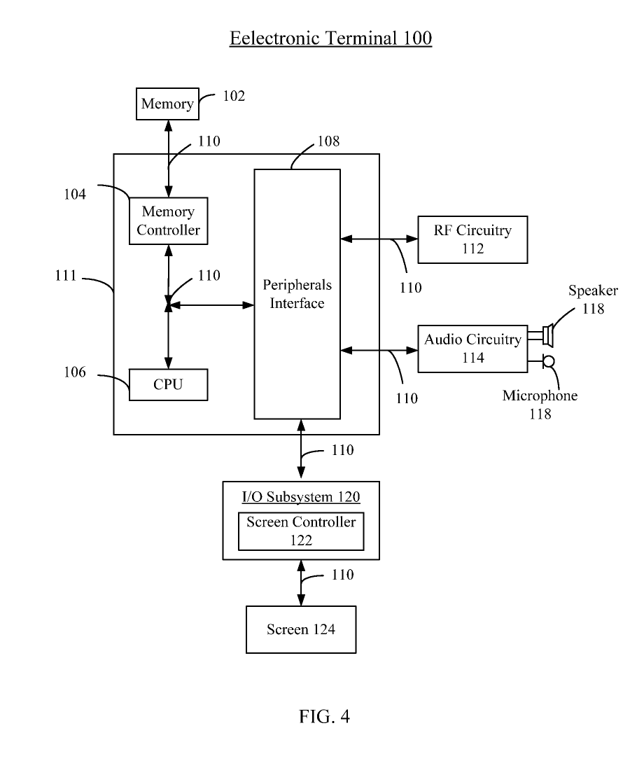

FIG. 4 is a block diagram illustrating an example of electronic terminal can be applied in the present disclosure.

The electronic terminal 100 includes a memory 102, a memory controller 104, one or more processing units (CPU's) 106, a peripherals interface 108, RF circuitry 112, audio circuitry 114, a speaker 116, a microphone 118, an input/output (I/O) subsystem 120, and a screen 124 These components communicate over the one or more communication buses or signal lines 110. It should be appreciated that the electronic terminal 100 is only one example of a portable electronic device 100, and that the electronic terminal 100 may have more or fewer components than shown, or a different configuration of components. The various components shown in FIG. 4 may be implemented in hardware, software or a combination of both of hardware and software, including one or more signal processing and/or application specific integrated circuits.

The memory 102 may be used to store software programs and modules, such as the program instructions/modules corresponding to the method and device for reservation on the electronic terminal in the present disclosure. The processing unit 106 performs a variety of functions and data processing by running the software program and the module stored in the memory 102, which implements the above method for reservation on the electronic terminal. The memory 102 may include high speed random access memory and may also include non-volatile memory, such as one or more magnetic disk storage devices, flash memory devices, or other non-volatile solid state memory devices. The memory 102 may further include storage remotely located from the one or more processors 106, for instance network attached storage accessed via the RF circuitry 112 or external port 148 and a communications network (not shown) such as the Internet, intranet(s), Local Area Networks (LANs), Wide Local Area Networks (WLANs), Storage Area Networks (SANs) and the like, or any suitable combination thereof. Access to the memory 102 by other components of the device 100, such as the CPU 106 and the peripherals interface 108, may be controlled by the memory controller 104.

The peripherals interface 108 couples the input and output peripherals of the device to the CPU 106 and the memory 102. The one or more processors 106 run various software programs and/or sets of instructions stored in the memory 102 to perform various functions for the electronic terminal 100 and to process data.

The peripherals interface 108, the CPU 106, and the memory controller 104 may be implemented on a single chip, such as a chip 111. Alternatively, they may be implemented on separate chips.

The RF (radio frequency) circuitry 112 receives and sends electromagnetic waves. The RF circuitry 112 converts electrical signals to/from electromagnetic waves and communicates with communications networks and other communications devices via the electromagnetic waves. The RF circuitry 112 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 112 may communicate with the networks, such as the Internet, also referred to as the World Wide Web (WWW), an Intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS)), or any other suitable communication protocol, including communication protocols not yet developed as of the filing date of this document.

The audio circuitry 114, the speaker 116, and the microphone 118 provide an audio interface between a user and the device 100. The audio circuitry 114 receives audio data from the peripherals interface 108, converts the audio data to an electrical signal, and transmits the electrical signal to the speaker 116. The speaker converts the electrical signal to human-audible sound waves. The audio circuitry 114 also receives electrical signals converted by the microphone 116 from sound waves. The audio circuitry 114 converts the electrical signal to audio data and transmits the audio data to the peripherals interface 108 for processing. Audio data may be may be retrieved from and/or transmitted to the memory 102 and/or the RF circuitry 112 by the peripherals interface 108.

The I/O subsystem 120 provides the interface between input/output peripherals on the device 100, such as the screen 124. The I/O subsystem 120 includes a screen controller 122. The screen 124 provides an output interface between the device and a user. The screen controller 122 sends electrical signals to the screen 124. The screen 124 displays visual output to the user. The visual output may include text, graphics, video, and any combination thereof.

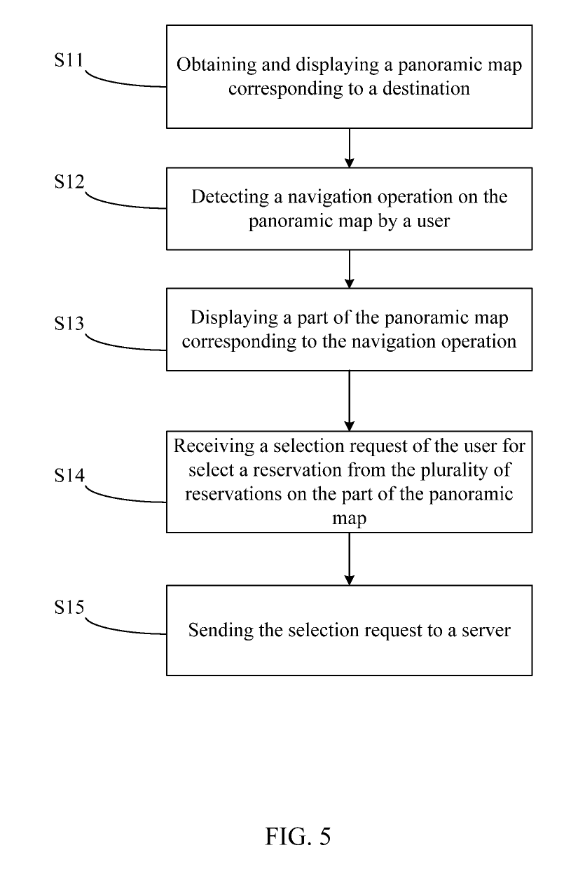

FIG. 5 is a flowchart of one embodiment of a method for reservation based on a panoramic map on an electronic terminal in accordance with the present disclosure.

In Step 11, a panoramic map corresponding to a destination is obtained and displayed, wherein the panoramic map has a plurality of reservations displayed thereon.

Before the Step 11, the electronic terminal may receive information of a destination entered by a user. The information of the destination includes address, phone number, and/or name of the destination, for example. The electronic terminal, as a client, may send the information of the destination to a server. The server may search the information of the destination in an E-map database, and feedback the location information of the destination to the electronic terminal. The location information of the destination may be displayed in the E-map on the electronic terminal

The E-map, for example, is a traditional E-map with a plurality of POIs (Point Of Interest) displayed thereon. The E-map database may include data of the POIs. The POI is usually a specific point location that someone may find useful or interesting or important, such as a housing estate, a school, a hospital, a shopping mall, a supermarket, an office, a restaurant, a hotel, a parking lot, etc. In the exemplary embodiment, the POI includes a restaurant. The data of the POI may include name, address, and phone number of the restaurant.

The information of the destination may be compared with data of the POIs, at the server, for example. If the information of the destination matches data of one POI, the POI may be determined to be a target POI. In the exemplary embodiment, the sever may get the location information of the destination according to the target POI and feed it back to the electronic terminal to display it on the E-map. The E-map displayed on the electronic terminal may include panoramic map interface of each POI. The electronic terminal may detect a selection operation (click on for example) of the panoramic map interface corresponding to the target POI, i.e. the destination, by users. In response to the selection operation, the electronic terminal may get and display the panoramic map corresponding to the destination. In the exemplary embodiment, the panoramic map may have a plurality of reservations displayed thereon.

In alternative embodiments, when the server gets the location information of the destination, the server may directly get the panoramic map corresponding to the destination from the panoramic map database, according to the location information of the destination and feed it back to the electronic terminal. The electronic terminal may receive and display the panoramic map. The panoramic map is any wide-angle view or representation of a physical space, whether in painting, drawing, photography, film, or a three-dimensional model. If the panoramic map has a big size, and the screen of the electronic terminal cannot display whole of the panoramic map, the electronic terminal can display a preset part of the panoramic map to users. The preset part of the panoramic map, for example, is the part of the panoramic map that includes the most reservations.

In Step 12, a navigation operation on the panoramic map by a user is detected.

The navigation operation on the panoramic map may include the operation of pan up, down, left or right in the panoramic map, or the operation of zoom in or zoom out, and so on. Once the users click the navigating buttons on the panoramic map, the corresponding navigation operation is detected by the electronic terminal.

In Step 13, in response to the navigation operation, a part of the panoramic map corresponding to the navigation operation is displayed, to make the user select a reservation on the part of the panoramic map.

In Step 14, a selection request for selecting a reservation from the plurality of reservations on the part of the panoramic map is received.

The user may send the selection request to the electronic terminal by clicking on one of the reservations in the panoramic map. In Step 15, the selection request is sent to a server, to make a reservation.

The method for reservation based on a panoramic map on an electronic terminal displays a panoramic map of the destination to users, and receives the selection request for selecting a reservation on the part of the panoramic map by users. In the present disclosure, users can know the actual location and surroundings of various reservation in the real world, and make a reservation according to the actual location and surroundings of various reservation, intuition and accuracy of reservation is significantly improved.

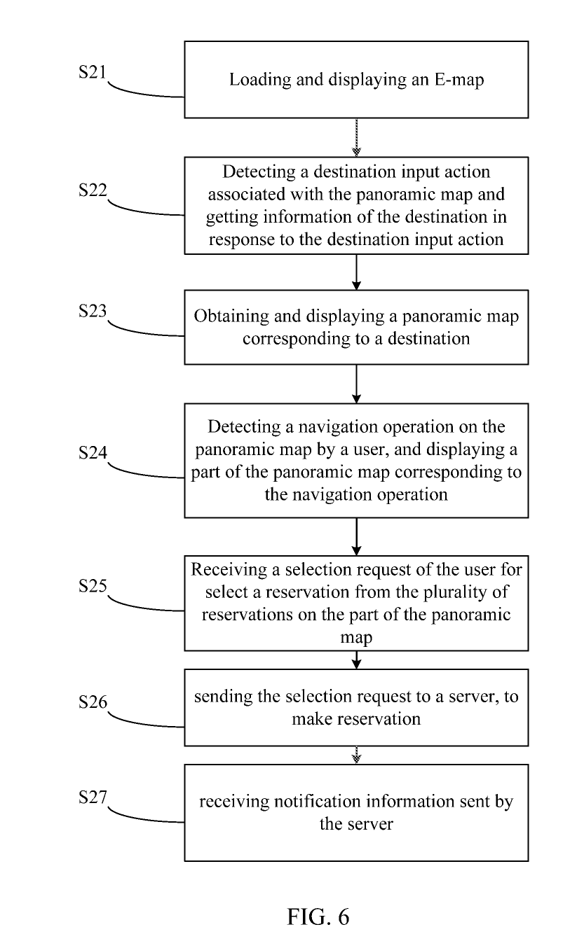

FIG. 6 is a flowchart of another embodiment of a method for reservation based on a panoramic map on an electronic terminal in accordance with the present disclosure.

In Step 21, an E-map is loaded and displayed, wherein the E-map includes a plurality of panoramic maps.

In one embodiment, the E-map maybe an electronic map that can provide Street View. The Street View is a technology that collects multiple two-dimension images of a scene by professional camera, puts the multiple images together for gets a 360° panoramic by software, and displays the 360° panoramic for users by a special player. The two-dimension plan is simulated as the real three-dimensional space by the Street View. The Street View provides the users with the 360° panoramic manipulation functions for zooming and moving in all directions to achieve the effect of the real scenes is simulated and reproduced.

In one embodiment, data of the E-map may be stored on cloud servers and loaded on demand when the E-map data is used. For example, the electronic terminal gets location parameters of the user, and sends the location parameters to a cloud server. The location parameters may be location, and/or moving direction of the user. The cloud server may receive the location parameters from the electronic terminal, and send panoramic map corresponding to the location parameters to the electronic terminal. In the exemplary embodiment, the electronic terminal may store loaded panoramic map in local storage. When the user is at the same location and the same moving direction next time, the loaded panoramic map can be read from the local storage, to save network traffic. In alternative embodiments, the electronic terminal may download the whole data of the E-map in one shot from the cloud server, and save the whole data of the E-map in the local storage.

In Step 22, a destination input action associated with the panoramic map is detected, and information of the destination in response to the destination input action is obtained.

The information of the destination includes address, phone number, and name of the destination, for example.

In the exemplary embodiment, the electronic terminal may detect a destination input action associated with the panoramic map, and receives text information of a destination inputted by the user in response to the destination input action.

In alternative embodiments, the electronic terminal may detect a destination input action associated with the panoramic map, and gets an image of the destination that carries a QR Code (Quick Response Code) of the destination in response to the destination input actions. The QR Code of the destination is includes address information of the destination. The QR Code is two dimensional square bar codes that contain data of address information of the destination.

The electronic terminal scans and decodes the QR Code carried in the image of the destination to gets the address information of the destination. The QR Code may be published by the destination merchants through the network, or billboards, etc. In one embodiment, the electronic terminal downloads the image of the destination from a network server, response to destination input actions of the user. In one embodiment, the electronic terminal takes the image of the destination by calling camera, response to the destination input actions of the user.

In Step 23, a panoramic map corresponding to a destination is obtained and displayed, the panoramic map having a plurality of reservations displayed thereon.

In the exemplary embodiment, the electronic terminal may receive text information of a destination inputted by the user, and searches the location information of the destination in the E-map, according to the text information of the destination. The E-map, for example, is a traditional E-map which includes data of the POI (Point Of Interest).

The electronic terminal compares the text information of the destination with the data of the POI, to get a target POI that matches the text information of the destination, and gets the location information of the destination in the E-map according to the target POI.

The electronic terminal sends the location information of the destination to a server, and receives the panoramic map and information of multiple reservations corresponding to the destination back from the server.

In alternatively embodiments, the electronic terminal may get the image of the destination which carries QR Code of the information of the destination. The electronic terminal scans and decodes the QR Code carried in the image of the destination to gets the information of the destination. The electronic terminal compares the information of the destination with the data of the POI for get a target POI that matches the information of the destination, and gets the location information of the destination in the E-map according to the target POI. The electronic terminal sends the location information of the destination to the server, and receives the panoramic map and information of multiple reservations corresponding to the destination back from the server.

In Step 24, a navigation operation on the panoramic map by a user is detected, and a part of the panoramic map corresponding to the navigation operation in response to the navigation operation is displayed, to make the user select a reservation on the part of the panoramic map.

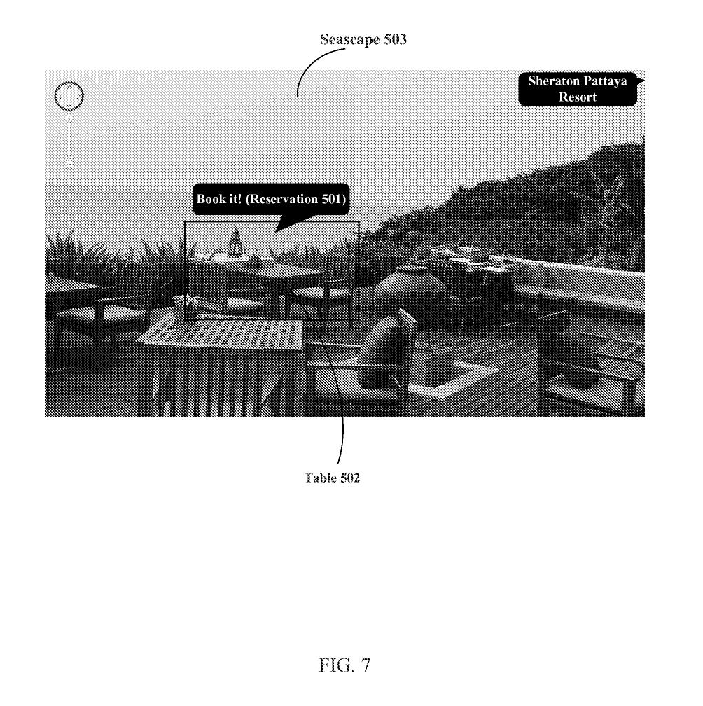

Referring to FIG. 7, for example, the destination is the Sheraton Pattaya Resort. FIG. 7 shows a part of the panoramic map of the Sheraton Pattaya Resort. There are multiple reservations displayed on the part of the panoramic map of the Sheraton Pattaya Resort, for example, a reservation 501 shown in FIG. 7. The reservation 501 is “the sea table 2”.

In the exemplary embodiment, the electronic terminal may display another part of the panoramic map of the Sheraton Pattaya Resort corresponding to a navigation operation on the panoramic map by the user.

The user may perform the navigation operation according to suggestion of route (not shown). The suggestion of route includes forward and backward. Forms of the suggestion of route may include arrow and other icons except for arrow. In alternative embodiments, the user may perform the navigation operation by moving the electronic terminal, for example, by rotating the electronic terminal around.

The electronic terminal displays the another part of the panoramic map corresponding to the navigation operation in response to the navigation operation, to make the user select a reservation on the part of the panoramic map. For example, in the another part of the panoramic map as shown in FIG. 7, there are the reservation 501 and a table 502 and a seascape 503. The user may make reservation by performing the reservation operation with the reservation 501 or the table 502.

In Step 25, a selection request for selecting a reservation from the plurality of reservations on the part of the panoramic map is received.

Referring to FIG. 7, the user may send the selection request to the electronic terminal by clicking on that the reservation 501 or the table 502 in the panoramic map. The selection request carries information of seat selected by the user.

In one embodiment, the electronic terminal displays a popup button “Book it!” on the panoramic map when the user right-click on the reservation 501 or the table 502. The electronic terminal receives the selection request from the user by right-clicking on the popup button “Book it!”.

The user may find other reservations by performing the reservation operation until a satisfied table is found, if not satisfied with the reservation 501.

In addition, the electronic terminal displays status of the plurality of reservations on the panoramic map. The status of each reservation includes reserved status or unreserved status. For example, the electronic terminal displays the “reserved” to notify the user that “the sea table 2” cannot be booked, if “the sea table 2” is reserved by other users. The user may book the other reservations when see the “reserved”.

In Step 26, the selection request is sent to a server, to make a reservation.

The server receives the selection request sent by the electronic terminal, and marks status of seat selected by the user corresponding to the selection request with “reserved”. The server generates notification information according to the selection request, and sends the notification information to the electronic terminal. The notification information may carry a code and reservation information associated with the selection request. The code may help the user acquire the service from the businesses. The reservation information may include information of reservation made by the user, such as, information of seat booked by the user, address and phone number of the business associated with the seat booked by the user, time of reservation, etc.

In Step 27, a notification information sent by the server is received, wherein the notification information carries a code and reservation information associated with the selection request.

The electronic terminal receives the notification information as a reservation confirmation sent by the server. The user may acquire the service from the businesses with the notification information.

In addition, the user may send the notification information by the electronic terminal to the other users such as friends whom the user dinner with, to help the other users may find the location of the reservation faster.

The method for reservation based on a panoramic map on an electronic terminal displays a panoramic map of the destination to users, and receives the selection request for selecting a reservation on the part of the panoramic map by users. In the present disclosure, users can know the actual location and surroundings of various reservation in the real world, and make a reservation according to the actual location and surroundings of various reservation, intuition and accuracy of reservation is significantly improved.

For example, the Users may enjoy surroundings of the restaurant through the panorama map shown in FIG. 7, so it is can provide more true sense and more immersive for the users, and significantly increase spending desires of the users. If the users see a seat they like (a seat with a nice view such as beside the window or beside the sea), the users may make reservation by clicking the table on the panorama, when the users see the panorama map of the restaurant. So the users can gain more real and easier experience of reservation by using the method for reservation based on a panoramic map on an electronic terminal.

It is possible to know the actual location and surroundings of various tables in the real world when the users make reservation by using the method for reservation based on a panoramic map in the present disclosure, so intuition and accuracy of reservation is significantly improved.

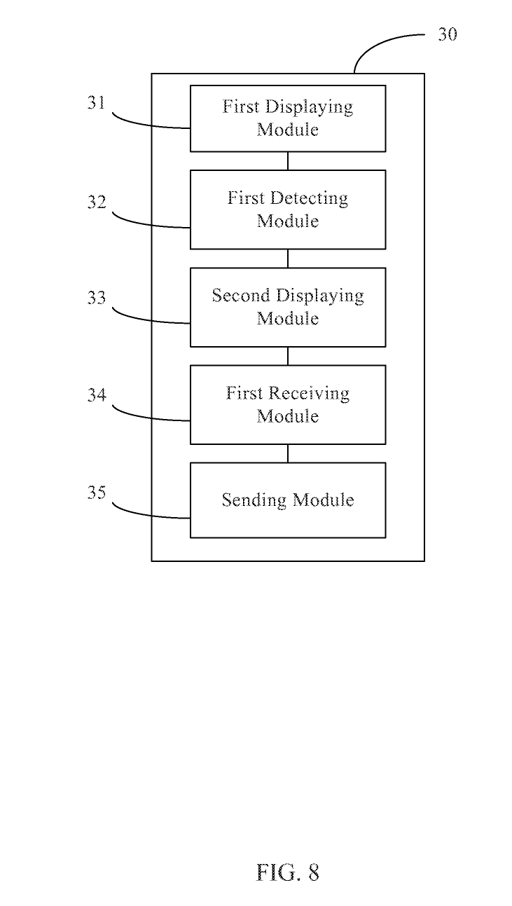

FIG. 8 is a schematic diagram of functional modules of one embodiment of an electronic terminal for reservation based on a panoramic map in accordance with the present disclosure. Referring to FIG. 8, the electronic terminal 30 includes a first displaying module 31, a first detecting module 32, a second displaying module 33, a first receiving module 34, and a sending module 35. The preceding modules may store in the memory 102.

The first displaying module 31 is configured to get and display a panoramic map corresponding to a destination, the panoramic map having a plurality of reservations displayed thereon.

The first detecting module 32 is configured to detect a navigation operation on the panoramic map by a user.

The second displaying module 33 is configured to display a part of the panoramic map corresponding to the navigation operation in response to the navigation operation, to make the user select a reservation on the part of the panoramic map.

The first receiving module 34 is configured to receive a selection request of the user for select a reservation from the plurality of reservations on the part of the panoramic map.

The sending module 35 is configured to send the selection request to a server, to make reservation.

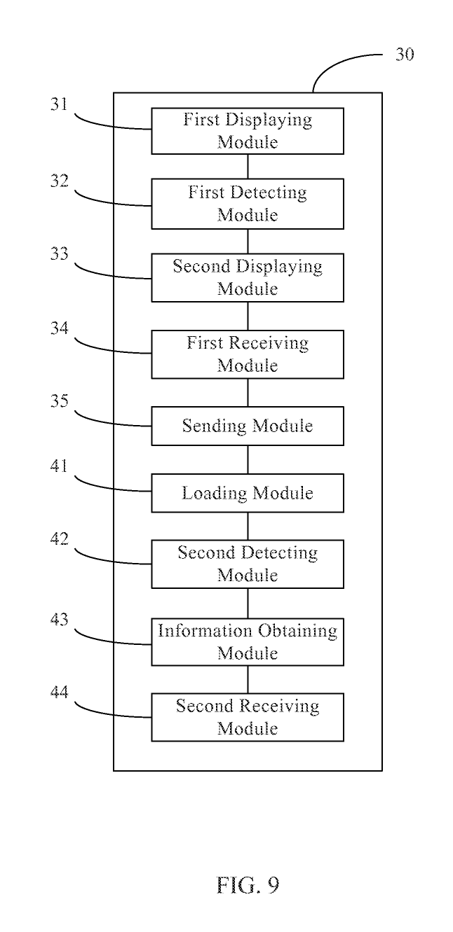

In addition, as shown in FIG. 9, the device 30 is further includes a loading module 41, a second detecting module 42, an information obtaining module 43 and a second receiving module 44.

The loading module 41 is configured to load and display an E-map, wherein the E-map includes a plurality of panoramic maps;

The second detecting module 42 is configured to detect a destination input action associated with the panoramic map; and

The information obtaining module 43 is configured to get information of the destination.

The second receiving module 44 is configured to receive notification information sent by the server, wherein the notification information carries a code and reservation information associated with the selection request.

In addition, status of the plurality of reservations is displayed on the panoramic map.

In addition, the status of each reservation includes reserved status or unreserved status.

The device for reservation based on a panoramic map on an electronic terminal displays a panoramic map of the destination to users, and receives the selection request for selecting a reservation on the part of the panoramic map by users. In the present disclosure, users can know the actual location and surroundings of various reservation in the real world, and make a reservation according to the actual location and surroundings of various reservation, intuition and accuracy of reservation is significantly improved.

According to above embodiments, it is possible to know the actual position situation of various tables in the real world when the user makes reservation by using the method, the device and the storage medium for reservation based on a panoramic map on an electronic terminal, so the intuition and accuracy of reservation is significantly improved.

What's more, various devices provided by the embodiments of the disclosure discussed above is done for illustration purposes only, and should not be taken as limitations of the general principles of the device for reservation on electronic terminal provided by the embodiment of the disclosure. It will be understood that various combinations and changes in the form and details of the device illustrated may be made by those skilled in the art without departing from the disclosure.

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. A “tangible” computer-readable medium expressly excludes software per se (not stored on a tangible medium) and a wireless, air interface. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps. Program modules may also comprise any tangible computer-readable medium in connection with the various hardware computer components disclosed herein, when operating to perform a particular function based on the instructions of the program contained in the medium.

The above descriptions are only preferred embodiments of the present disclosure, and are not intended to limit the present disclosure. Any amendments, replacement and modification made to the above embodiments under the spirit and principle of the present disclosure should be included in the scope of the present disclosure.

What is claimed is:

1. A method for reservation based on a panoramic map on an electronic terminal, at the electronic terminal, the method comprising:
obtaining and displaying a panoramic map corresponding to a destination, the panoramic map having a plurality of reservations displayed thereon;
detecting a navigation operation on the panoramic map by a user;
in response to the navigation operation, displaying a part of the panoramic map corresponding to the navigation operation, to make the user select a reservation on the part of the panoramic map;
receiving a selection request for selecting a reservation from the plurality of reservations on the part of the panoramic map; and
sending the selection request to a server, to make reservation.

2. The method as described in claim 1, before the step of obtaining and displaying a panoramic map corresponding to a destination, further comprising:
loading and displaying an E-map, wherein the E-map comprises a plurality of panoramic maps;
detecting a destination input action associated with the panoramic map; and
in response to the destination input action, obtaining information of the destination.

3. The method as described in claim 1, wherein status of the plurality of reservations is displayed on the panoramic map.

4. The method as described in claim 3, wherein the status of each reservation comprises reserved status or unreserved status.

5. The method as described in claim 1, further comprising:
receiving notification information sent by the server, wherein the notification information carries a code and reservation information associated with the selection request.

6. A device for reservation based on a panoramic map on an electronic terminal, the device comprising at least a processor operating in conjunction with a memory and a plurality of modules, wherein the plurality of modules comprises:
a first displaying module, configured to get and display a panoramic map corresponding to a destination, the panoramic map having a plurality of reservations displayed thereon;
a first detecting module, configured to detect a navigation operation on the panoramic map by a user;
a second displaying module, configured to display a part of the panoramic map corresponding to the navigation operation in response to the navigation operation, to make the user select a reservation on the part of the panoramic map;
a first receiving module, configured to receive a selection request of the user for select a reservation from the plurality of reservations on the part of the panoramic map; and
a sending module, configured to send the selection request to a server, to make reservation.

7. The device as described in claim 6, further comprising:
a loading module, configured to load and display an E-map, wherein the E-map comprises a plurality of panoramic maps;
a second detecting module, configured to detect a destination input action associated with the panoramic map; and
an information obtaining module, configured to get information of the destination.

8. The device as described in claim 6, wherein status of the plurality of reservations is displayed on the panoramic map.

9. The device as described in claim 8, wherein the status of each reservation comprises reserved status or unreserved status.

10. The device as described in claim 6, further comprising:
a second receiving module, configured to receive notification information sent by the server, wherein the notification information carries a code and reservation information with the selection request.

11. A non-transitory computer-readable storage medium storing instructions for starting an application in an electronic terminal, the instructions comprising:
obtaining and displaying a panoramic map corresponding to a destination, the panoramic map having a plurality of reservations displayed thereon;
detecting a navigation operation on the panoramic map by a user;
in response to the navigation operation, displaying a part of the panoramic map corresponding to the navigation operation, to make the user select a reservation on the part of the panoramic map;
receiving a selection request for selecting a reservation from the plurality of reservations on the part of the panoramic map; and
sending the selection request to a server, to make reservation.

12. The non-transitory computer-readable storage medium as described in claim 11, before the step of obtaining and displaying a panoramic map corresponding to a destination, further comprising:
loading and displaying an E-map, wherein the E-map comprises a plurality of panoramic maps;
detecting a destination input action associated with the panoramic map; and
in response to the destination input action, obtaining information of the destination.

13. The non-transitory computer-readable storage medium as described in claim 11, wherein status of the plurality of reservations is displayed on the panoramic map.

14. The non-transitory computer-readable storage medium as described in claim 13, wherein the status of each reservation comprises reserved status or unreserved status.

15. The non-transitory computer-readable storage medium as described in claim 11, further comprising:
receiving notification information sent by the server, wherein the notification information carries a code and reservation information associated with the selection request.
